(19) United States
(12) Patent Application Publication
(10) Pub. No.: US 2025/0105561 A1
(43) Pub. Date: Mar. 27, 2025

(54) ELECTRICAL CONNECTOR

(71) Applicant: Molex, LLC, Lisle, IL (US)

(72) Inventor: Ya Feng, Chengdu (CN)

(21) Appl. No.: 18/815,885

(22) Filed: Aug. 27, 2024

(30) Foreign Application Priority Data
Sep. 27, 2023 (CN) 202322645416.6

(51) Int. Cl. H01R 13/6594

(52) U.S. Cl. CPC H01R 13/6594

(57) ABSTRACT

An electrical connector includes: an insulative housing, a front end of the insulative housing is provided with at least one mating cavity; at least one insulative base received in the insulative housing, a protrusion protrudes from the insulative base; at least one circuit board mounted to a side of the insulative base; a plurality of conductive terminals provided in the mating cavity and electrically connecting with the circuit board; a shielding cage which covers an exterior of the insulative housing and exposes the mating cavity; a rear portion of the shielding cage is provided with at least one first grounding elastic piece which bends forwardly, the first grounding elastic piece electrically connects with the circuit board, the first grounding elastic piece is provided with a locking hole, the protrusion latches in the locking hole. By latching between the first grounding elastic piece and the protrusion, movement of the shielding cage along the front-rear direction is limited, ground reliability of the electrical connector is assured.

### TECHNICAL FIELD

The present disclosure relates to the technical field of connectors, and particularly relates to an electrical connector which has a grounding elastic piece.

### BACKGROUND

Chinese patent document CN111755916B discloses an electrical connector which includes an insulative base, a plurality of terminals, an internal circuit board and a metal shielding cage. The internal circuit board is provided to the insulative base, and the internal circuit board is provided with ground pads, the ground pads and the insulative base are formed therebetween with an inserting gap. The metal shielding cage is provided to the insulative base, and the metal shielding cage has ground tongues, the ground tongue has a contacting segment, the contacting segment has a top surface and a bulge formed to an opposite side of the top surface, a distance between a top surface of the contacting segment of the ground tongue and a bottom surface of the bulge is larger than a distance of the inserting gap, the ground tongue inserts into the inserting gap and the contacting segment of the ground tongue is clamped between the insulative base and the ground pad, the bottom surface of the bulge contacts the ground pad.

However, in this technical solution, that the insulative base and the ground pad together clamp the ground tongue cannot very firmly limit movement of the ground tongue in a front-rear direction, the ground tongue possibly moves in a vibrating circumstance and in turn does not contact the ground pad, which results in that ground performance of the electrical connector will not reliable, therefor it needs to be further improved.

### SUMMARY

A technical problem to be solved by the present disclosure is to provide an electrical connector which is reliable in ground performance so as to overcome the deficiency existing in the above prior art.

In order to solve the above technical problem, the present disclosure provides an electrical connector comprising: an insulative housing, a front end of the insulative housing is provided with at least one mating cavity; at least one insulative base received in the insulative housing, a protrusion protrudes from the insulative base; at least one circuit board mounted to a side of the insulative base; a plurality of conductive terminals provided in the mating cavity and electrically connecting with the circuit board; a shielding cage which covers an exterior of the insulative housing and exposes the mating cavity; a rear portion of the shielding cage is provided with at least one first grounding elastic piece which bends forwardly, the first grounding elastic piece electrically connects with the circuit board, the first grounding elastic piece is provided with a locking hole, the protrusion latches in the locking hole.

In an embodiment, the rear portion of the shielding cage is provided with at least one window, the first grounding elastic piece comprises a horizontal extending portion which connects with an edge of the window and a contacting portion which bends from the horizontal extending portion toward the circuit board, the locking hole is provided in the horizontal extending portion.

In an embodiment, the first grounding elastic piece is positioned between the insulative base and the circuit board, the contacting portion bends rearwardly from a front edge of the horizontal extending portion, the circuit board is provided with a ground pad, the contacting portion elastically contacts the ground pad.

In an embodiment, at least one mating cavity are arranged in a way that stack up and down in pair, an upper side and a lower side of the insulative base each are provided with one circuit board, the contacting portion of the first grounding elastic piece bends upwardly from the horizontal extending portion and contacts the circuit board which is positioned above the insulative base.

In an embodiment, a bottom portion of the shielding cage bends and forms at least one second grounding elastic piece, the second grounding elastic piece is provided with an opening, and an elastic arm obliquely extends forwardly from a rear edge of the opening, the elastic arm contacts the circuit board which is positioned below the insulative base.

In an embodiment, the shielding cage comprises a bottom plate which is positioned to the bottom portion of the shielding cage, the second grounding elastic piece bends from a rear end of the bottom plate, the elastic arm elastically contacts the circuit board, which is positioned below the insulative base, from up to down.

In an embodiment, the locking hole penetrates up and down; a rear side of the protrusion has a slope, a front side of the protrusion has a vertical abutting surface, the abutting surface abuts against an edge of the locking hole.

In an embodiment, the shielding cage comprises a rear plate and two side plates which are respectively arranged at two sides of the rear plate, the first grounding elastic piece extends forwardly from the rear plate, the rear plate is further provided with a strengthening protrusion which protrudes rearwardly, the strengthening protrusion extends horizontally toward two sides of the rear plate.

In an embodiment, the shielding cage comprises a rear plate and two side plates which are respectively arranged at two sides of the rear plate, the two side plates are respectively arranged at a left side and a right side of the insulative housing, at least one clip bends forwardly from the rear edge of the each side plate, the clips are used to fix the rear plate.

In an embodiment, the two sides of the rear plate each bend forwardly and form a bending edge, the bending edge attaches to an outer side of the side plate, and the bending edge is provided with a through hole, the clip extends out of the bending edge via the through hole and clips an outer side of the bending edge.

In comparison with the prior art, the present disclosure at least has following advantages: in the electrical connector of the present disclosure, the first grounding elastic piece of the shielding cage is provided with a locking hole, a protrusion protrudes from the insulative base, the protrusion latches in the locking hole. By latching between the locking hole of the first grounding elastic piece and the protrusion, movement of the first grounding elastic piece along the front-rear direction is limited, the stable electrical connection between the shielding cage and the circuit board is assured, in turn ground reliability of the electrical connector is assured.

### BRIEF DESCRIPTION OF THE DRAWINGS

FIG. 1 is a perspective view of a preferred embodiment of an electrical connector of the present disclosure.

FIG. 2 is a perspective view of FIG. 1 from another angle.

FIG. 3 is a partially enlarged view of a part A of FIG. 2.

FIG. 4 is a rear view of FIG. 1.

FIG. 5 is a cross-sectional view along a line B-B of FIG. 4.

FIG. 6 is a partial enlarged view of a part C of FIG. 5.

FIG. 7 is a partial enlarged view f a part D of FIG. 5.

FIG. 8 is a perspective exploded view of the electrical connector of the present disclosure.

FIG. 9 is a perspective exploded view of FIG. 8 from another angle.

FIG. 10 is a perspective exploded view of FIG. 8 from still another angle.

FIG. 11 is a partial enlarged view of a part E of FIG. 10.

FIG. 12 is a partial enlarged view of a part F of FIG. 10.

FIG. 13 is a perspective exploded view further exploded on a basis of FIG. 10.

### DETAILED DESCRIPTION

While the present disclosure may be susceptible to embodiments in different forms, there are shown in the figures, and will be described herein in detail, are only specific embodiments, with the understanding that the present disclosure is to be considered as an exemplification of the principles of the present disclosure and is not intended to limit the present disclosure to that as illustrated.

Hence references to a feature are intended to describe a feature of an embodiment of the present disclosure, not to imply that every embodiment thereof must have the described feature. Furthermore, it should be noted that the description illustrates several features. While certain features have been combined to illustrate potential system designs, those features may also be used in other combinations not expressly disclosed. Thus, the depicted combinations are not intended to be limiting, unless otherwise noted.

In the embodiments illustrated in the figures, representations of directions such as up, down, left, right, front and rear, used for explaining the structure and movement of the various parts of the present disclosure, are not absolute, but relative. These representations are appropriate when the parts are in the position shown in the figures. If the description of the position of the parts changes, however, these representations are to be changed accordingly.

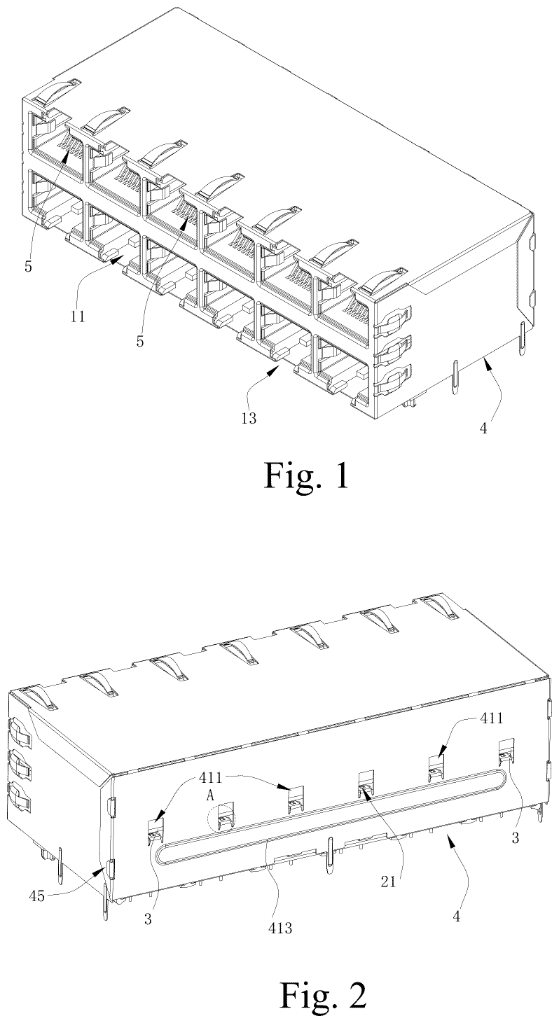

Referring to FIG. 1 to FIG. 5, the present preferred embodiment of the electrical connector includes an insulative housing 1, at least one insulative base 2, at least one circuit board 3, a plurality of conductive terminals 5 and a shielding cage 4. A protrusion 21 protrudes from the insulative base 2. At least one first grounding elastic piece 46 forwardly bends from a rear portion of the shielding cage 4. The first grounding elastic piece 46 is provided with a locking hole 464, the protrusion 21 latches in the locking hole 464, in turn limits the first grounding elastic piece 46 to displace along a front-rear direction, makes a stable electrical connection between the shielding cage 4 and the circuit board 3 established, and in turn assures ground reliability of the electrical connector.

For sake of convenient description, in the electrical connector, a mating end of the electrical connector is defined as front, a direction away from the mating end is defined as rear, and directions perpendicular to the front-rear direction are defined as left and right.

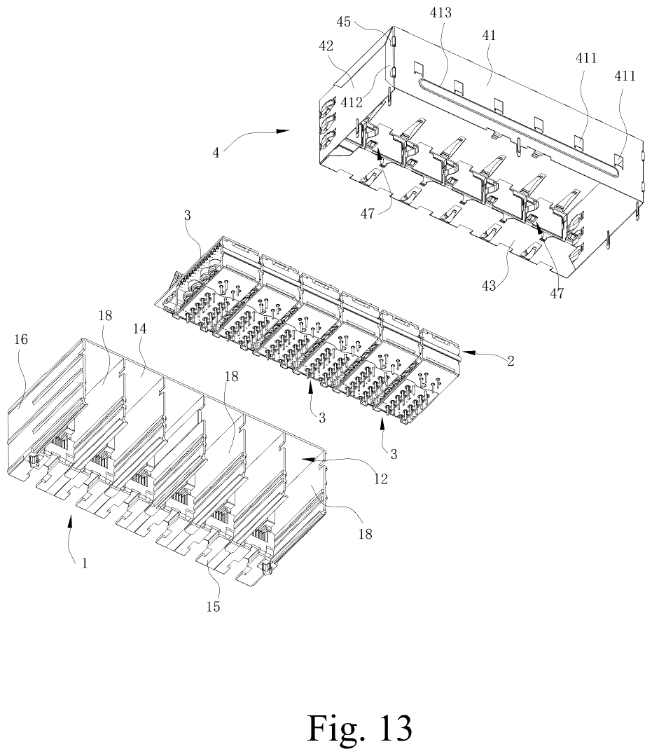

In combination with FIG. 8 to FIG. 10 and FIG. 13, a front end of the insulative housing 1 is provided with a plurality of mating cavities 11, a rear end of the insulative housing 1 also is provided with a plurality of receiving cavities 12, an inserting port 13 is formed in the front of each mating cavity 11.

The mating cavities 11 are arranged in a way that stack up and down in pair. In the present embodiment, the number of the mating cavities 11 is twelve (12) which are distributed as 6×2, i.e. the insulative housing 1 is provided with two layers of mating cavities 11 up and down and each layer of mating cavities 11 has six mating cavities 11. In other implementing manners, the number of the mating cavities 11 further may be only two which are arranged up and down, also may be four or other number, and is specifically provided depend on practical need.

The plurality of receiving cavities 12 are provided to the rear end of the insulative housing 1, each receiving cavity 12 is provided corresponding to the two mating cavities 11 which are arranged in pair, i.e. in the present embodiment, the insulative housing 1 is provided with six receiving cavities 12 therein. And each receiving cavity 12 is communicated with the two corresponding mating cavities 11.

Specifically, the insulative housing 1 includes a top wall 14, a bottom wall 15 and two side walls 16 which respectively connect left sides and right sides of the top wall 14 and the bottom wall 15. The top wall 14, the bottom wall 15 and the two side walls 16 enclose and form the insulative housing 1 which has a receiving space therein. In the present embodiment, the insulative housing 1 is in form of square.

As shown in FIG. 8 to FIG. 10, the insulative housing 1 further includes a partitioning wall 17 which extends horizontally and a plurality of vertical partitioning plates 18, the partitioning wall 17 is parallel to and spaced apart from the top wall 14 and the bottom wall 15, the plurality of vertical partitioning plates 18 are parallel to and spaced apart from each other, and respective vertical partitioning plates 18 are parallel to side plates 42 to partition an interior of the insulative housing 1 into spaces which are independent of each other to form the plurality of mating cavities 11 and the plurality of receiving cavities 12.

Furthermore, the top wall 14 rearwardly exceeds the partitioning wall 17 and the bottom wall 15, a front end of the partitioning wall 17, a front end of the bottom wall 15, a front end of the top wall 14 and front ends of the plurality of vertical partitioning plates 18 together enclose and form the plurality of mating cavities 11, a rear end of the top wall 14 and rear ends of the plurality of vertical partitioning plates 18 together enclose and form the plurality of receiving cavities 12, i.e. a bottom portion and a rear portion of each receiving cavity 12 are opened.

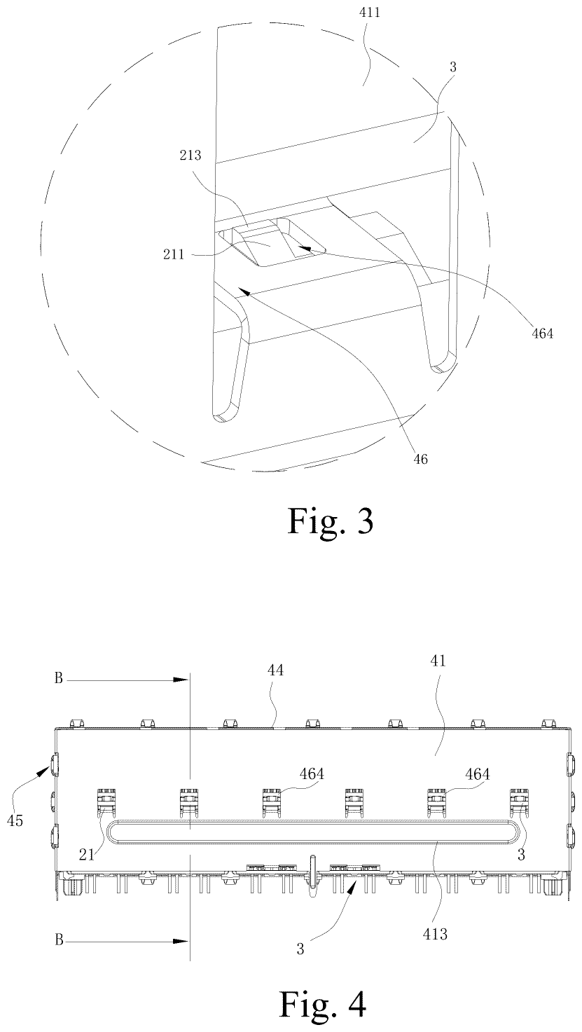

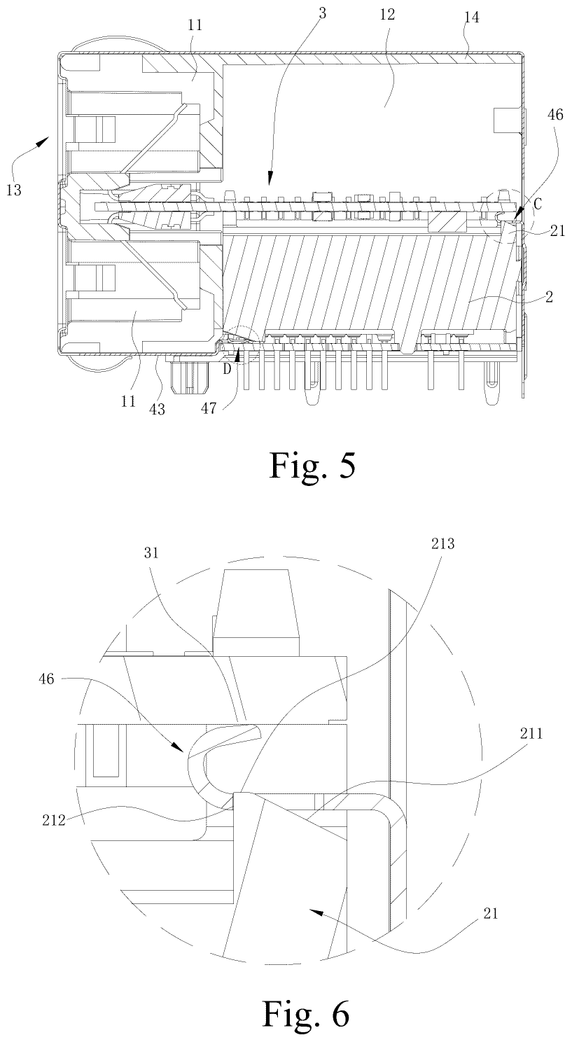

The insulative base 2 is correspondingly received in each receiving cavity 12, in combination with FIG. 3, FIG. 5 and FIG. 6, the insulative base 2 is provided to a lower portion of the receiving cavity 12, the protrusion 21 protrudes upwardly from the insulative base 2, the protrusion 21 is provided to a top portion of the insulative base 2; in some implementing manners not shown, the protrusion 21 also may protrude downwardly from a bottom portion of the insulative base 2.

As shown in FIG. 6, a rear side of the protrusion 21 has a slope 211 to facilitate that the protrusion 21 smoothly enters the locking hole 464 of the first grounding elastic piece 46. Specifically, the slope 211 gradually inclines downwardly from front to rear.

A front side of the protrusion 21 has a vertical abutting surface 212 and is used to abut against an edge of the locking hole 464. The protrusion 21 is further provided with an extending surface 213 which is horizontal and is at a top portion of slope 211.

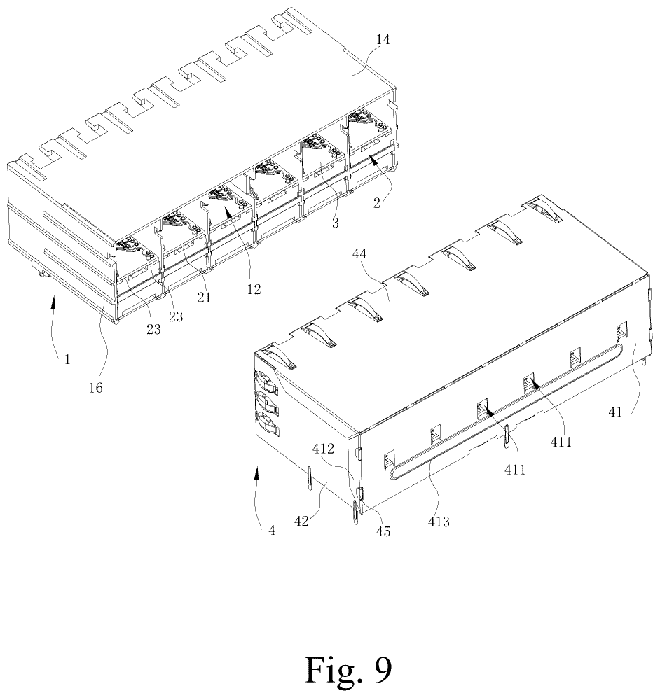

As shown in FIG. 9, an upper side and a lower side of the insulative base 2 each are provided with one circuit board 3. A rear end of the insulative base 2 has two protruding bars 23 which protrude upwardly, the two protruding bar 23 are respectively positioned to a left side and a right side of the protrusion 21, support the circuit board 3 which is positioned above the insulative base 2 to make the circuit board 3 and a top portion of the protrusion 21 have a gap therebetween, the first grounding elastic piece 46 may extend into the gap to latch the protrusion 21.

Each circuit board 3 is provided with a ground pad, and connects with the shielding cage 4 by the ground pad to realize grounding. In the present embodiment, a bottom portion of the circuit board 3 positioned above the insulative base 2 is provided with an upper ground pad 31, a top portion of the circuit board 3 positioned below the insulative base 2 is provided with a lower ground pad 32.

The plurality of conductive terminals 5 are divided into groups and are correspondingly provided in the plurality of mating cavities 11, each group of conductive terminals 5 has multiple conductive terminals 5, and the groups of conductive terminals 5 electrically connect the circuit boards 3 respectively.

In combination with FIG. 8 to FIG. 10 and FIG. 13, the shielding cage 4 covers an exterior of the insulative housing 1 and exposes the plurality of mating cavities 11 and each inserting port 13. The shielding cage 4 includes a rear plate 41 and two side plates 42 respectively arranged at two sides of the rear plate 41. A bottom portion of the shielding cage 4 is provided with a bottom plate 43, top portions of the two side plates 42 are connected with a top plate 44, i.e. the top plate 44, the bottom plate 43, the two side plates 42 and the rear plate 41 enclose and form the shielding cage 4.

The two side plates 42 are respectively arranged at a left side and a right side of the insulative housing 1, the top plate 44 is positioned above the top wall 14 of the insulative housing 1, the bottom plate 43 is positioned below the bottom wall 15 of the insulative housing 1, i.e. is positioned to the bottom portions of the plurality of mating cavities 11, the rear plate 41 is positioned behind the insulative housing 1. At least one clip 45 bends forwardly from of the rear edge of each side plate 42, the clips 45 are used to fix the rear plate 41. Specifically, the clips 45 of the two side plates 42 respectively hook a left side and a right side of the rear plate 41, to fix and straighten the rear plate 41, and prevent a middle of the rear plate 41 from arching rearwardly to generate deformation.

In the present embodiment, each side plate 42 is provided with the two clips 45, the two clips 45 are spaced apart from each other along an up-down direction. In other implementing manners, the number of the clip 45 further may be other number and is specifically provided depend on practical need.

Specifically, the two sides of the rear plate 41 each are formed with a bending edge 412 which bends forwardly, the bending edge 412 attaches to an outer side of the side plate 42. And the bending edge 412 is provided with a through hole, the clip 45 extends out of the bending edge 412 via the through hole and clips an outer side of the bending edge 412.

Furthermore, the rear plate 41 is further provided with a strengthening protrusion which protrudes rearwardly, the strengthening protrusion extends horizontally toward the two sides of the rear plate 41, to strengthen strength of the rear plate 41 and prevent the rear plate 41 from generating deformation.

In the present embodiment, a left side and a right side of the top plate 44 respectively further bend downwardly to form two bent edges, the two bent edge respectively attach to the outer sides of the two side plates 42.

The rear plate 41 of the shielding cage 4 is provided with at least one window 411. In the present embodiment, the number of the window 411 is six, each window 411 corresponds to one receiving cavity 12.

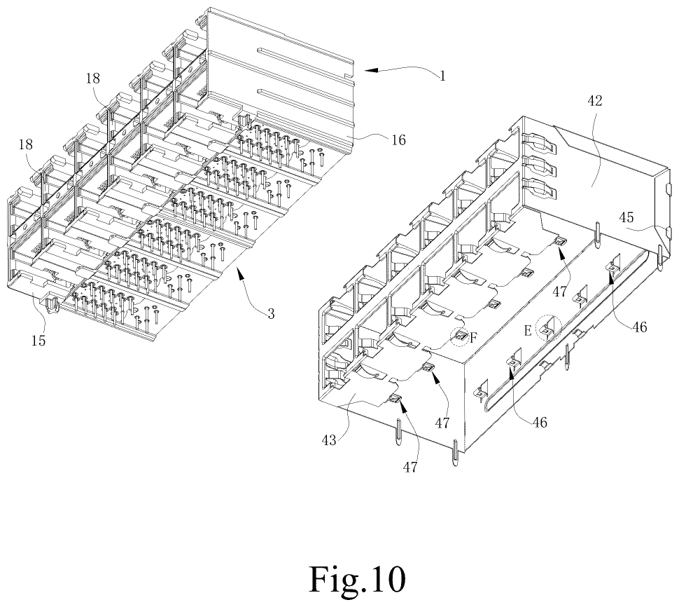

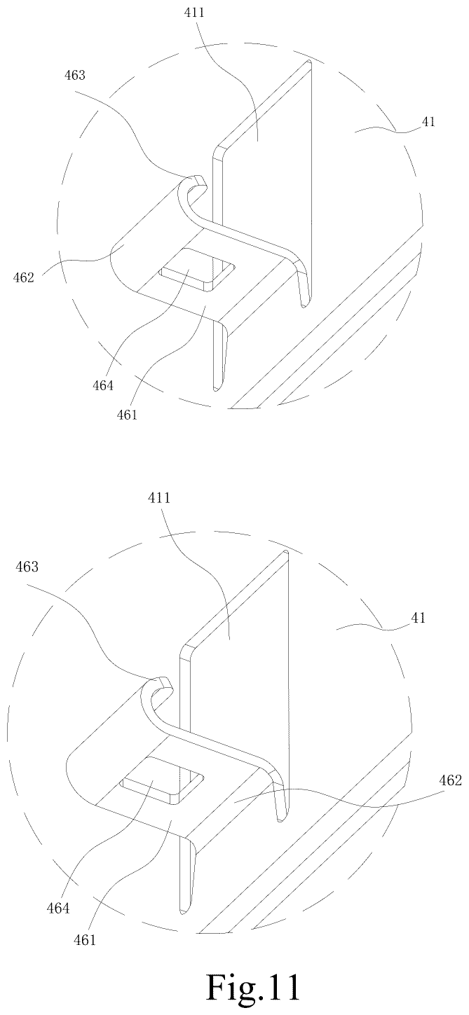

In combination with FIG. 6, FIG. 10 and FIG. 11, the first grounding elastic piece 46 is positioned between the insulative base 2 and the circuit board 3. The first grounding elastic piece 46 includes a horizontal extending portion 461 which is connected with an edge of the window 411 and a contacting portion 463 which bends from the horizontal extending portion 461 toward the circuit board 3.

Specifically, the contacting portion 463 bends rearwardly from a front edge of the horizontal extending portion 461, the contacting portion 463 elastically contact the upper ground pad 31 to make the first grounding elastic piece 46 and the circuit board 3 electrically connected. Specifically, in the present embodiment, a curving portion 462 is curved integrally from a lower edge of the window 411 toward the receiving cavity 12, the horizontal extending portion 461 integrally extends forwardly from the curving portion 462, an end of the horizontal extending portion 461 away from the curving portion 462 integrally bends upwardly back to form the contacting portion 463.

The horizontal extending portion 461 horizontally extends along the front-rear direction. The locking hole 464 is provided in the horizontal extending portion 461, and penetrates the horizontal extending portion 461 up and down. The locking hole 464 may be provided to a middle of the horizontal extending portion 461, also may be provided to a side portion of the horizontal extending portion 461 close to an edge of the horizontal extending portion 461.

When an operator downwardly bends the rear plate 41 of the shielding cage 4, the first grounding elastic piece 46 extends into below the circuit board 3 from rear to front via the gap between the circuit board 3 and the insulative base 2, the slope 211 of the protrusion 21 provides guiding for movement of the first grounding elastic piece 46 to make the protrusion 21 smoothly latch into the locking hole 464, at this time, the contacting portion 463 of the first grounding elastic piece 46 is just right aligned with the upper ground pad 31 of the circuit board 3 which is positioned above the insulative base 2, by elasticity of the first grounding elastic piece 46, the upper ground pad 31 of the circuit board 3 and the first grounding elastic piece 46 are assured to reliably contact each other in the up-down direction, a stable electrical connection between a ground end of the circuit board 3 and the shielding cage 4 is established, that the circuit board 3 is reliably grounded is realized. At the same time, also by latching between the protrusion 21 and the first grounding elastic piece 46, movement of the first grounding elastic piece 46 along the front-rear direction is limited, which assures stable contact between the contacting portion 463 and the upper ground pad 31 in the horizontal direction and further promotes ground reliability.

In other implementing manners not shown, the contacting portion 463 further may be electrically connected with the upper ground pad 31 by other manners, by for example soldering. The horizontal extending portion 461 further may be modified to connect with an upper edge of the window 411.

The bottom plate 43 of the shielding cage 4 is positioned to the bottom portions of the plurality of mating cavities 11 and exposes the bottom portions of the plurality of receiving cavities 12. The bottom portion of the shielding cage 4 bends and forms at least one second grounding elastic piece 47, the second grounding elastic piece 47 contacts the circuit board 3 which is positioned below the insulative base 2 to realize grounding of the circuit board 3 which is positioned below the insulative base 2.

Specifically, in the present embodiment, the number of the second grounding elastic piece 47 is six, the second grounding elastic piece 47 and the circuit board 3 which is positioned below the insulative base 2 are provided as one-to-one correspondence. In other implementing manners, the circuit board 3 which is positioned below the insulative base 2 further may be electrically connected with the circuit board 3, which is positioned above the insulative base 2, via other circuit connecting structure, such as a Flexible Flat Cable or a ground pin and the like, to realize grounding, at this time, the second grounding elastic piece 47 need not be provided.

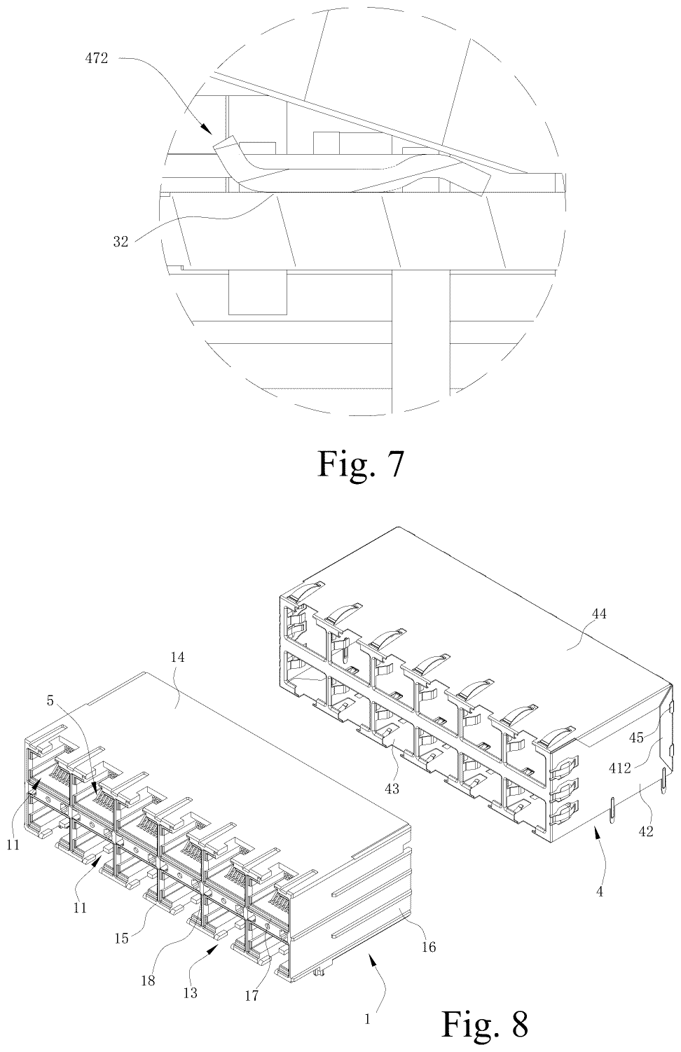

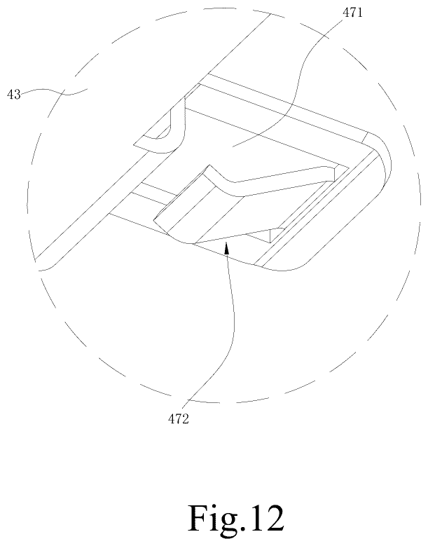

In combination with FIG. 7, FIG. 10 and FIG. 12, the second grounding elastic piece 47 bends from a rear end of the bottom plate 43. The second grounding elastic piece 47 is provided with an opening 471, and an elastic arm 472 obliquely extends forwardly from a rear edge of the opening 471, the elastic arm 472 contacts the circuit board 3 which is positioned below the insulative base 2. Specifically, the elastic arm 472 elastically contacts the circuit board 3, which is positioned below the insulative base 2, from up to down.

In the present embodiment, firstly, the elastic arm 472 obliquely extend downwardly from a rear edge of the opening 471, then obliquely bends upwardly at a tip of the elastic arm 472, and an outer periphery of the elastic arm 472 is transited by rounding and smoothing at the bending location. The bending location elastically contacts the lower ground pad 32 of the circuit board 3.

By that the second grounding elastic piece 47 electrically connects with the circuit board 3 which is positioned below the insulative base 2, grounding of the circuit board 3 which is positioned below the insulative base 2 is realized. And because the latching between the insulative base 2 and the shielding cage 4, movement between the insulative base 2 and the shielding cage 4 along the front-rear direction is limited, in turn firm connection between the second grounding elastic piece 47 and the circuit board 3 which is positioned below the insulative base 2 is also assured.

In the electrical connector of the present embodiment, by latching between the first grounding elastic piece 46 of the shielding cage 4 and the protrusion 21 of the insulative base 2, rearward sliding of the first grounding elastic piece 46 is limited, the electrical connection between the first grounding elastic piece 46 and the circuit board 3 which is positioned above the insulative base 2 is assured, in turn reliable ground performance of the electrical connector is assured. By contacting between the second grounding elastic piece 47 of the bottom portion of the shielding cage 4 and the circuit board 3 which is positioned below the insulative base 2, the electrical connection between the second grounding elastic piece 47 and the circuit board 3 which is positioned below the insulative base 2 is realized, in turn the reliable grounding of each circuit board 3 which is positioned below the insulative base 2 is realized.

Although the present disclosure has been described with reference to several typical embodiments, it should be understood that the terminology used is illustrative and exemplary rather than limiting. Since the present disclosure can be embodied in various forms without departing from the spirit or essence of the present disclosure, it should be understood that the above embodiments are not limited to any of the foregoing details, but should be widely interpreted within the spirit and scope defined by the appended claims, therefore, all variations and modifications falling within the scope of the claims or equivalent ranges of the claims should be covered by the appended claims.

1. An electrical connector, comprising:
an insulative housing, a front end of the insulative housing being provided with at least one mating cavity;
at least one insulative base received in the insulative housing, a protrusion protruding from the insulative base;
at least one circuit board mounted to a side of the insulative base;
a plurality of conductive terminals provided in the mating cavity and electrically connecting with the circuit board;
a shielding cage which covers an exterior of the insulative housing and exposes the mating cavity; a rear portion of the shielding cage being provided with at least one first grounding elastic piece which bends forwardly, the first grounding elastic piece electrically connecting with the circuit board, the first grounding elastic piece being provided with a locking hole, the protrusion latching in the locking hole.

2. The electrical connector of claim 1, wherein
the rear portion of the shielding cage is provided with at least one window,
the first grounding elastic piece comprises a horizontal extending portion which connects with an edge of the window and a contacting portion which bends from the horizontal extending portion toward the circuit board,
the locking hole is provided in the horizontal extending portion.

3. The electrical connector of claim 2, wherein
the first grounding elastic piece is positioned between the insulative base and the circuit board,
the contacting portion bends rearwardly from a front edge of the horizontal extending portion,
the circuit board is provided with a ground pad, the contacting portion elastically contacts the ground pad.

4. The electrical connector of claim 3, wherein
at least one mating cavity are arranged in a way that stack up and down in pair,
an upper side and a lower side of the insulative base each are provided with one circuit board,
the contacting portion of the first grounding elastic piece bends upwardly from the horizontal extending portion and contacts the circuit board which is positioned above the insulative base.

5. The electrical connector of claim 4, wherein
a bottom portion of the shielding cage bends and forms at least one second grounding elastic piece,
the second grounding elastic piece is provided with an opening, and an elastic arm obliquely extends forwardly from a rear edge of the opening, the elastic arm contacts the circuit board which is positioned below the insulative base.

6. The electrical connector of claim 5, wherein
the shielding cage comprises a bottom plate which is positioned to the bottom portion of the shielding cage,
the second grounding elastic piece bends from a rear end of the bottom plate,
the elastic arm elastically contacts the circuit board, which is positioned below the insulative base, from up to down.

7. The electrical connector of claim 1, wherein
the locking hole penetrates up and down;
a rear side of the protrusion has a slope, a front side of the protrusion has a vertical abutting surface, the abutting surface abuts against an edge of the locking hole.

8. The electrical connector of claim 1, wherein
the shielding cage comprises a rear plate and two side plates which are respectively arranged at two sides of the rear plate,
the first grounding elastic piece extends forwardly from the rear plate,
the rear plate is further provided with a strengthening protrusion which protrudes rearwardly, the strengthening protrusion extends horizontally toward two sides of the rear plate.

9. The electrical connector of claim 1, wherein
the shielding cage comprises a rear plate and two side plates which are respectively arranged at two sides of the rear plate,
the two side plates are respectively arranged at a left side and a right side of the insulative housing, at least one clip bends forwardly from the rear edge of each side plate, the clips are used to fix the rear plate.

10. The electrical connector of claim 9, wherein
the two sides of the rear plate each bend forwardly and form a bending edge, the bending edge attaches to an outer side of the side plate, and the bending edge is provided with a through hole, the clip extends out of the bending edge via the through hole and clips an outer side of the bending edge.
